(19) United States
(12) Patent Application Publication
(10) Pub. No.: US 2020/0122273 A1
(43) Pub. Date: Apr. 23, 2020

(54) METHOD AND DEVICE FOR CUTTING BATTERY ELECTRODE

(71) Applicant: SZ DJI TECHNOLOGY CO., LTD., Shenzhen (CN)

(72) Inventors: Bogao XU, Shenzhen (CN); Lei WANG, Shenzhen (CN)

(21) Appl. No.: 16/717,190

(22) Filed: Dec. 17, 2019

Related U.S. Application Data
(63) Continuation of application No. PCT/CN2017/090813, filed on Jun. 29, 2017.

(51) Int. Cl. B23K 26/364; H01M 4/04; B23K 26/08; B23K 26/06; B23K 26/40; B23K 26/38

(52) U.S. Cl. CPC B23K 26/364; H01M 4/0471; B23K 26/0876; B23K 2101/38; B23K 26/083; B23K 26/40; B23K 26/38; B23K 26/0626

(57) ABSTRACT

A method for cutting a battery electrode includes determining whether a portion of the battery electrode that is currently being cut is one of a plurality of electrode tabs or one of gap portions each being between two adjacent ones of the plurality of electrode tabs, and controlling one or more cutting parameters of a laser generator based on a determination result. The one or more cutting parameters of the laser generator are different for cutting the one of the electrode tabs from for cutting the one of the gap portions.

### CROSS-REFERENCE TO RELATED APPLICATION

This application is a continuation of International Application No. PCT/CN2017/090813, filed on Jun. 29, 2017, the entire content of which is incorporated herein by reference.

### TECHNICAL FIELD

The present disclosure relates to unmanned aerial vehicle technologies and, more particularly, to a method and a battery electrode cutting device.

### BACKGROUND

A battery of an unmanned aerial vehicle often has a large discharge current, which requires use of battery cells having a low internal resistance and a good kinetic performance. The low internal resistance often means that the battery electrode needs to include a plurality of electrode tabs.

In the existing technology, the battery electrode is often cut by an electrode tab laser cutting machine. The electrode tab laser cutting machine may include a laser generator. Laser light emitted from the laser generator cuts the battery electrode to form the plurality of electrode tabs, forming gap portions between neighboring ones of the plurality of electrode tabs. In a normal operation, the battery electrode moves at a constant velocity and the laser generator emits the laser light at a fixed power.

However, if the power of the laser generator is about just enough for cutting a gap portion, the laser generator may sometimes be unable to cut an electrode tab completely apart from the remaining electrode, thereby resulting in burrs along an electrode tab contour. Thus, battery cell performance may be degraded.

### SUMMARY

In accordance with the disclosure, there is provided a method for cutting a battery electrode including determining whether a portion of the battery electrode that is currently being cut is one of a plurality of electrode tabs or one of gap portions each being between two adjacent ones of the plurality of electrode tabs, and controlling one or more cutting parameters of a laser generator based on a determination result. The one or more cutting parameters of the laser generator are different for cutting the one of the electrode tabs from for cutting the one of the gap portions.

Also in accordance with the disclosure, there is provided a battery electrode cutting device including a laser generator and a controller electrically connected to the laser generator and configured to determine whether a portion of the battery electrode that is currently being cut is one of a plurality of electrode tabs or one of gap portions each being between two adjacent ones of the plurality of electrode tabs, and control one or more cutting parameters of a laser generator based on a determination result. The one or more cutting parameters of the laser generator are different for cutting the one of the electrode tabs from for cutting the one of the gap portions

### BRIEF DESCRIPTION OF THE DRAWINGS

To more clearly illustrate the technical solution of the present disclosure, the accompanying drawings used in the description of the disclosed embodiments are briefly described hereinafter. The drawings described below are merely some embodiments of the present disclosure. Other drawings may be derived from such drawings by a person with ordinary skill in the art without creative efforts and may be encompassed in the present disclosure.

FIG. 1 is a flow chart of a method for cutting a battery electrode according to an example embodiment.

FIG. 2 is a schematic diagram of a battery electrode cutting device according to an example embodiment.

FIG. 3 is a schematic diagram of a battery electrode according to an example embodiment.

FIG. 4 is a schematic diagram of a battery electrode cutting device according to another example embodiment.

FIG. 5 is a schematic diagram of a battery electrode according to another example embodiment.

FIG. 6 is a schematic diagram of a battery electrode cutting device according to another example embodiment.

### REFERENCE NUMERALS

20 battery electrode cutting device,
21 laser generator,
22 laser light,
23 battery electrode,
24 movable member,
25 controller,
31 electrode tab,
32 gap portion,
34 lengthwise direction of battery electrode,
35 lengthwise direction of battery electrode,
36 widthwise direction of battery electrode,
37 widthwise direction of battery electrode,
38 beveled edge of electrode tab,
39 beveled edge of electrode tab,
60 battery electrode cutting device,
61 controller,
62 laser generator, and
63 movable member.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

It should be noted that, in some embodiments, when one component is “fixedly connected” or “connected” to another component, or one component is “fixed” to another component, the component may directly contact the another component, or may not directly contact the another component and may have something in-between.

Unless otherwise specified, all the technical and scientific terms used in the embodiments of the present disclosure refer to the same meaning commonly understood by those skilled in the art. The terminologies used in the present disclosure are intended to describe specific embodiments, and not to limit the scope of the present disclosure. The term “and/or” includes any and all combinations of one or more of the listed items.

Embodiments of the present disclosure are described in detail below with reference to the accompanying drawings. Features of the embodiments and examples described below may be combined with each other under the circumstances of non-conflicting.

Generally, when an electrode tab laser cutting machine cuts a battery electrode, a laser generator of the electrode tab laser cutting machine may emit laser light, e.g., a laser beam. The laser light may start to cut the battery electrode along a movement direction of the battery electrode. It is assumed that the battery electrode moves at a velocity V1 in a lengthwise direction (longitudinal direction). A gap portion between two adjacent electrode tabs is a straight line. When an electrode tab needs to be cut, the battery electrode continues to move at a constant velocity. At the same time, the laser generator moves rapidly in a widthwise direction (lateral direction) to cut out a contour of the electrode tab. Then, the laser generator returns to its original position rapidly and continues to cut the gap portion between the two adjacent electrode tabs. It is assumed that the laser generator moves at a velocity V2 when cutting the electrode tab.

When the laser light cuts the gap portion between the two adjacent electrode tabs, the battery electrode moves at the velocity V1 with respect to the laser generator. When the laser light cuts the electrode tab, the battery electrode moves relative to the laser generator at a combined velocity V=V1+V2. The magnitude of the combined velocity V is greater than the magnitude of the velocity V1. The length of a gap portion that can be cut by the laser light within a unit time t is V1*t. Correspondingly, the length of an electrode tab contour that can be cut by the laser light within the unit time t is V*t. Because the magnitude of the combined velocity V is greater than the magnitude of the velocity V1, the length of the electrode tab contour that the laser light cuts in the unit time t is greater than the length of the gap portion that the laser light cuts in the unit time t.

If the laser generator emits the laser light at a fixed power, the laser generator may emit a fixed amount of laser energy in the unit time t. Because the length of the electrode tab contour that the laser light cuts in the unit time t is greater than the length of the gap portion that the laser light cuts in the unit time t, the laser energy that a unit length of the electrode tab contour receives in the unit time t may be smaller than the laser energy that a unit length of the gap portion receives in the unit time t. Therefore, if the power of the laser light is about just enough to cut through the battery electrode at the gap portion, the laser generator may be unable to cut through the battery electrode at the electrode tab, resulting in burrs along the electrode tab contour. Thus, the battery cell performance may be degraded. On the other hand, if the power of the laser light is about just enough to cut through the electrode at the electrode tab, then when the laser generator cuts the gap portion, the gap portion may be over-melt due to the excessive amount of laser energy. To solve the foregoing problem, the embodiments of the present disclosure provide a method for cutting the battery electrode, as described below in details with some embodiments.

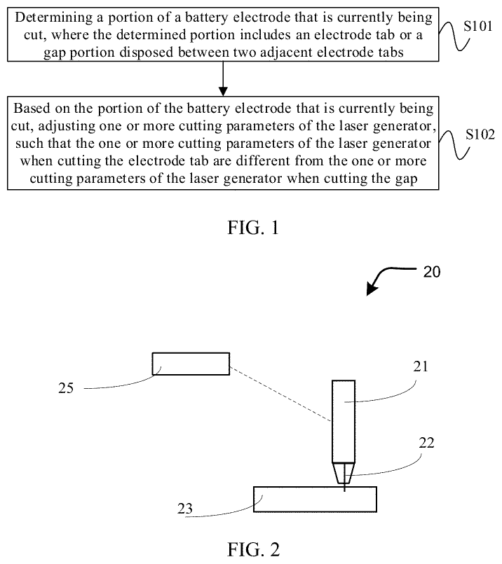

The present disclosure provides the method for cutting the battery electrode. FIG. 1 is a flow chart of a method for cutting a battery electrode according to an example embodiment. As shown in FIG. 1, at S101, a portion of a battery electrode that is currently being cut is determined, where the determined portion of the battery electrode includes an electrode tab or a gap portion disposed between two adjacent electrode tabs.

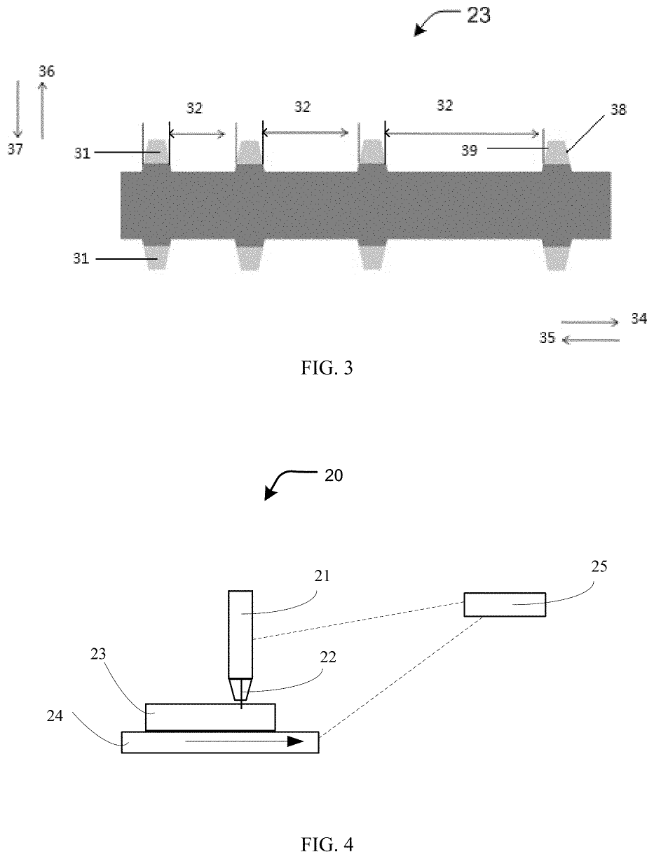

FIG. 2 is a schematic diagram of a device 20 for cutting a battery electrode (“battery electrode cutting device” or simply “cutting device”) according to an example embodiment. As shown in FIG. 2, the battery electrode cutting device 20 includes a laser generator 21. The battery electrode cutting device 20 may be an electrode tab laser cutting machine. The laser light 22 emitted from the laser generator 21 cuts the battery electrode 23. FIG. 3 illustrates a plurality of electrode tabs 31 and gap portions 32 each being between two adjacent electrode tabs. The drawing is for illustrative purposes and does not limit a number of the electrode tabs or a number of the gap portions. In addition, different gap portions 32 may have different lengths. In some embodiments, the battery electrode 23 may be a lithium battery electrode. The lithium battery may be used for powering an unmanned aerial vehicle.

During the process that the laser light 22 emitted from the laser generator 21 cuts the battery electrode 23, the battery electrode 23 moves relative to the laser generator 21. The movement of the battery electrode 23 relative to the laser generator may include the following scenarios.

In some embodiments, as shown in FIG. 4, the battery electrode cutting device 20 includes a movable member 24 carrying the battery electrode 23. The movable member 24 drives the battery electrode 23 to move. In this case, the laser light 22 emitted from the laser generator 21 may be relatively stationary.

In some embodiments, the laser light 22 emitted from the laser generator 21 moves. Specifically, the laser generator 21 moves or a laser head of the laser generator 21 moves. In this case, the battery electrode 23 may be relatively stationary.

In some embodiments, when the laser generator 21 cuts the gap portion, the movable member 24 drives the battery electrode to move. The laser light 22 emitted from the laser generator 21 may be relatively stationary. When the laser generator 21 cuts the electrode tabs, the movable member 24 continues to drive the battery electrode 23 to move. At the same time, the laser light 22 emitted from the laser generator 21 moves in the widthwise direction of the battery electrode 23. Unless otherwise specified, in this disclosure, a direction along a longer length is referred to as the lengthwise direction (longitudinal direction) and a direction along a shorter length is referred to as the widthwise direction (lateral direction). As shown in FIG. 3, the arrow 34 and the arrow 35 point to the lengthwise directions of the battery electrode 23 and the arrow 36 and the arrow 37 point to the widthwise directions. Similarly, a velocity along the lengthwise direction (longitudinal direction) is also referred to as a lengthwise velocity (longitudinal velocity) and a velocity along the widthwise direction (lateral direction) is also referred to as a widthwise velocity (lateral velocity).

In some embodiments, as shown in FIG. 2 or FIG. 4, the battery electrode cutting device 20 further includes a controller 25. As shown in FIG. 2, the controller 25 is electrically connected to the laser generator 21. The controller 25 may control the laser light 22 emitted from the laser generator 21 to move. For example, the controller 25 may control the laser generator 21 to move or may control the laser head of the laser generator 21 to move. As shown in FIG. 4, the controller 25 may be electrically connected to the laser generator 21 and the movable member 24 carrying the battery electrode 23. The controller 25 may not only control the laser light 22 emitted from the laser generator 21 to move, but also control the movable member 24 to move.

In some embodiments, the method for cutting the battery electrode may be implemented by the controller 25 of the battery electrode cutting device 20. The controller 25 may determine the portion of the battery electrode 23 that the laser generator 21 currently cuts. As shown in FIG. 3, the portion of the battery electrode 23 that the laser generator 21 currently cuts may be the electrode tab 31 of the battery electrode 23 or the gap portion 32 between adjacent battery electrodes 23. The controller 25 may determine the portion of the battery electrode 23 that the laser generator 21 currently cuts in one of the following manners.

In some embodiments, the controller 25 may recognize the portion of the battery electrode 23 that the laser generator currently cuts based on whether the laser light 22 emitted from the laser generator 21 moves. For example, when the laser generator 21 cuts the gap portion 32, the movable member 24 drives the battery electrode 23 to move. The laser light 22 emitted from the laser generator 21 is relatively stationary. When the laser generator 21 cuts the electrode tab 31, the movable member 24 still drives the battery electrode 23 to move. At the same time, the laser light 22 emitted from the laser generator 21 moves in the widthwise direction of the battery electrode 23. Thus, when the laser light 22 emitted from the generator 21 moves, the controller 25 may determine that the portion of the battery electrode 23 that the laser generator 21 currently cuts is the electrode tab 21. When the laser light 22 emitted from the laser generator 21 is stationary, the controller 25 may determine that the portion of the battery electrode 23 that the laser generator 21 currently cuts is the gap portion 32.

In some embodiments, timing for cutting the electrode tabs 31 (e.g., time points for starting to cut the electrode tabs 31) and timing for cutting the gap portion 32 (e.g., time points for starting to cut the gap portions 32) may be pre-stored in the controller 25. The controller 25 may cut the electrode tabs 31 and the gap portions 32 alternately according to the pre-stored time schedule.

In some embodiments, attribute information of the battery electrode 23 may be pre-stored in the controller 25. For example, the attribute information may include a length and a width of the battery electrode 23, a number of the electrode tabs 31 that need to be cut, a height of each electrode tab 31, and a length of the gap portion 32 between adjacent electrode tabs 31, etc. Based on the attribute information of the battery electrode 23, the controller 23 may calculate the time for cutting the electrode tabs 31 and the time for cutting the gap portions 32 and may cut the electrode tabs 31 and the gap portions 32 alternately.

At S102, based on the portion of the battery electrode that is currently being cut, one or more cutting parameters of the laser generator are adjusted, such that the one or more cutting parameters of the laser generator when cutting the electrode tab are different from the one or more cutting parameters of the laser generator when cutting the gap portion.

After the controller 25 determines the portion of the battery electrode 23 that is currently cut, the controller 25 may adjust the one or more cutting parameters of the laser generator 21 based on the portion of the battery electrode 23 that is currently cut, such that the laser generator 21 has different cutting parameters when cutting different positions on the battery electrode 23. For example, the cutting parameters of the laser generator 21 for cutting the electrode tab 31 are different from the cutting parameters of the laser generator 21 for cutting the gap portion 32.

In some embodiments, the cutting parameters may include at least one of a power of the laser light emitted from the laser generator 21 or a velocity at which the battery electrode 23 moves relative to the laser generator 21.

The velocity at which the battery electrode 23 moves relative to the laser generator 21 may include at least one of the velocity at which the battery electrode 23 moves relative to the laser generator 21 in the lengthwise direction or the velocity at which the battery electrode 23 moves relative to the laser generator 21 in the widthwise direction. The gap portion 32 is arranged in the lengthwise direction.

For example, when the laser generator 21 cuts the electrode tab 31, the velocity at which the battery electrode 23 moves relative to the laser generator 21 may include the velocity at which the battery electrode 23 moves relative to the laser generator 21 in the lengthwise direction and the velocity at which the battery electrode 23 moves relative to the laser generator 21 in the widthwise direction. When the laser generator 21 cuts the gap portion 32, the velocity at which the battery electrode 23 moves relative to the laser generator 21 may include the velocity at which the battery electrode 23 moves relative to the laser generator 21 in the lengthwise direction.

In addition, the velocity at which the battery electrode 23 moves relative to the laser generator 21 may include at least one of a velocity at which the movable member 24 carrying the battery electrode 23 moves or a velocity at which the laser light 22 emitted from the laser generator 21 moves. Thus, the velocity at which the battery electrode 23 moves relative to the laser generator 21 in the widthwise direction may include at least one of a velocity at which the laser light 22 emitted from the laser generator 21 moves in the widthwise direction of the battery electrode 23 or a velocity at which the movable member 24 carrying the battery electrode 23 moves in the widthwise direction of the battery electrode 23. The velocity at which the battery electrode 23 moves relative to the laser generator 21 in the lengthwise direction may include at least one of a velocity at which the movable member 24 carrying the battery electrode 23 moves in the lengthwise direction of the battery electrode 23 or a velocity at which the laser light 22 emitted from the laser generator 21 moves in the lengthwise direction of the battery electrode 23.

As shown in FIG. 3, the arrow 34 and the arrow 35 point to the lengthwise directions of the battery electrode 23. The arrow 36 and the arrow 37 point to the widthwise directions of the battery electrode 23. In some embodiments, when the laser generator 21 cuts the gap portion 32, the battery electrode 23 moves relative to the laser generator 21 in the direction pointed by the arrow 34. For example, the controller 24 controls the movable member 24 to move in the direction pointed by the arrow 34. When the laser generator 21 cuts the electrode tab 31, the battery electrode 23 moves relative to the laser generator 21 in the direction pointed by the arrow 34. At the same time, the battery electrode 23 moves relative to the laser generator 21 in the direction pointed by either the arrow 36 or the arrow 37. For example, when the laser generator 21 cuts a beveled edge 38 of the electrode tab 31, the controller 25 controls the movable member 24 to move in the direction pointed by the arrow 34 and at the same time controls the laser light 22 emitted from the laser generator 21 to move in the direction pointed by the arrow 36. When the laser generator 21 cuts a beveled edge 39 of the electrode tab 31, the controller 25 controls the movable member 24 to move in the direction pointed by the arrow 34 and at the same time controls the laser light 22 emitted from the laser generator 21 to move in the direction pointed by the arrow 37. As such, the contour of the electrode tab 31 is cut. After the laser generator 21 cuts the contour of the electrode tab 31, the controller 25 controls the laser light 22 emitted from the laser generator 21 to be relatively stationary and continues to control the movable member 24 to move in the direction pointed by the arrow 34. As such, the laser light 22 emitted from the laser generator 21 cuts the gap portion 32.

During the process that the laser generator 21 cuts the electrode tabs 31 and the gap portions 32 alternately, the battery electrode 23 continues to move relative to the laser generator in the lengthwise direction of the battery electrode 23, and the laser generator 21 continues to emit the laser light 22. When the laser generator 21 cuts the electrode tab 31, the battery electrode 23 moves relative to the laser generator 21 in the widthwise directions of the battery electrode 23. When the laser generator 21 cuts the gap portion 32, the battery electrode 23 is stationary relative to the laser generator 21 in the widthwise direction of the battery electrode 23.

In some embodiments, the controller 25 may control the laser generator 21 to cut the electrode tab 31 and the gap portion 32 with different powers. As such, the power at which the laser generator 21 cuts the electrode tab 31 is different from the power at which the laser generator 21 cuts the gap portion 32.

In addition, when the laser generator 21 cuts the electrode tab 31 or the gap portion 32, the controller 25 may also adjust the velocity at which the battery electrode 23 moves relative to the laser generator 21 in the lengthwise direction of the battery electrode 23. For example, the controller 25 may adjust the velocity at which the movable member 24 moves, such that the velocity at which the movable member 24 moves when the laser generator 21 cuts the electrode tab 31 is different from the velocity at which the movable member 24 moves when the laser generator 21 cuts the gap portion 32.

Further, the controller 25 may also simultaneously adjust the power of the laser generator 21 and the velocity at which the movable member 24 moves, such that the power at which the laser generator 21 cuts the electrode tab 31 is different from the power at which the laser generator 21 cuts the gap portion 32 and the velocity at which the movable member 24 moves when the laser generator 21 cuts the electrode tab 31 is different from the velocity at which the movable member 24 moves when the laser generator 21 cuts the gap portion 32.

In the embodiments of the present disclosure, the battery electrode cutting device determines the portion of the battery electrode that is currently cut. Based on the portion of the battery electrode that is currently cut, the cutting parameters of the laser generator are adjusted such that the cutting parameters of the laser generator cutting the electrode tab are different from the cutting parameters of the laser generator cutting the gap portion. Compared to the existing technology that the cutting parameters of the laser generator when cutting the electrode tab are the same as the cutting parameters of the laser generator when cutting the gap portion, the embodiments of the present disclosure avoid the problem that the laser generator is unable to cut the electrode tab completely apart from the remaining electrode because a unit length of the electrode tab contour receives less laser energy than a same unit length of the gap portion. Thus, the burrs may be avoided, and the battery cell performance may be improved.

The present disclosure provides the method for cutting the battery electrode. In some embodiments, the process of adjusting the cutting parameters of the laser generator based on the portion of the battery electrode that is currently cut may include the following. If the portion of the battery electrode that is currently cut is the electrode tab, the power of the laser light emitted from the laser generator is adjusted to a first power. If the portion of the battery electrode that is currently cut is the gap portion, the power of the laser light emitted from the laser generator is adjusted to a second power. The first power is greater than the second power.

In some embodiments, when the laser generator cuts the electrode tab or the gap portion, the battery electrode moves relative to the laser generator at a constant velocity in the lengthwise direction of the battery electrode.

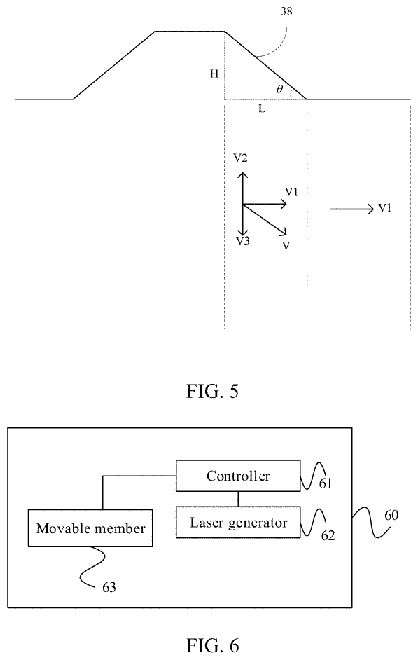

As shown in FIG. 5, it is assumed that when the laser generator cuts the gap portion, the movable member carrying the battery electrode moves at the velocity V1. When the laser generator cuts the electrode tab, the movable member carrying the battery electrode moves at the velocity V1 and the laser light emitted from the laser generator moves at the velocity V2. Thus, the battery electrode moves relative to the laser generator at the velocity V1 in the lengthwise direction of the battery electrode. The battery electrode moves relative to the laser generator at the velocity V3 in the widthwise direction of the battery electrode. V3 and V2 have an equal magnitude and opposite directions. The battery electrode moves relative to the laser generator at the velocity V that is a combination of V1 and V3. If the movable member carrying the battery electrode moves at the constant velocity when the laser generator cuts both the gap portion and the electrode tab, a length of the gap portion that the laser light cuts in the unit time t is V1*t and a length of the electrode tab contour that the laser light cuts in the unit time t is V*t. Because the magnitude of the combined velocity V is greater than the magnitude of V1, the length of the electrode tab contour that the laser light cuts in the unit time t is greater then the length of the gap portion that the laser light cuts in the unit time t.

In some embodiments, when the laser generator cuts the electrode tab, the controller may increase the power of the laser light emitted from the laser generator. For example, when the laser generator cuts the electrode tab, the controller adjusts the power of the laser light emitted from the laser generator to the first power. When the laser generator cuts the gap portion, the controller adjusts the power of the laser light emitted from the laser generator to the second power. The first power is greater than the second power. In the unit time t, the laser energy emitted from the laser generator cutting the electrode tab is greater than the laser energy emitted from the laser generator cutting the gap portion. Because the length of the electrode tab contour that the laser light cuts is longer than the length of the gap portion that the laser light cuts in the unit time t, a difference between the laser energy that the unit length of the electrode tab contour receives and the laser energy that the unit length of the gap portion receives may be within a preset energy range.

For example, a difference between the laser energy emitted from the laser generator that cuts a preset length of the electrode tab contour and the laser energy emitted from the laser generator that cuts the preset length of the gap portion is within the preset energy range. In some embodiments, the laser energy emitted from the laser generator that cuts the preset length of the electrode tab contour is equal to the laser energy emitted from the laser generator that cuts the preset length of the gap portion. That is, the laser energy that the unit length of the electrode tab contour receives is equal to the laser energy that the unit length of the gap portion receives.

In addition, in some embodiments, when the laser generator cuts the electrode tab and the gap portion, the battery electrode may move relative to the laser generator at different velocities in the lengthwise direction of the battery electrode. For example, the velocity at which the battery electrode moves relative to the laser generator in the lengthwise direction of the battery electrode when the laser generator cuts the electrode tab is smaller than the velocity at which the battery electrode moves relative to the laser generator in the lengthwise direction of the battery electrode when the laser generator cuts the gap portion. That is, as shown in FIG. 5, when the laser generator cuts the electrode tab, the controller may reduce the velocity V1 at which the movable member carrying the battery electrode moves. Compared to the scenario that the movable member moves at the constant velocity, the battery electrode spends longer time under the laser generator and receives more laser energy. That is, the unit length of the electrode tab contour receives more laser energy.

In some embodiments of the present disclosure, the controller controls the laser generator to cut the electrode tab and the gap portion at different powers, such that the power of the laser generator cutting the electrode tab is greater than the power of the laser generator cutting the gap portion. Compared to the existing technology, the unit length of the electrode tab contour receives more laser energy. As such, the laser energy that the unit length of the electrode tab contour receives is approximately equal to the laser energy that the unit length of the gap portion receives. The problem that the laser energy is not enough for cutting the electrode tab completely apart from the remaining electrode and burrs are present because the unit length of the electrode tab contour receives less laser energy than the unit length of the gap portion may be avoided. At the same time, the problem that the laser energy is about just enough for cutting the electrode tab but excessive for cutting the gap portion may be avoided.

The present disclosure provides the method for cutting the battery electrode. In the embodiments of the present disclosure, adjusting the cutting parameters of the laser generator based on the portion of the battery electrode that is currently cut includes the following. If the portion of the battery electrode that is currently cut is the electrode tab, the velocity at which the battery electrode moves relative to the laser generator in the lengthwise direction of the battery electrode is adjusted to be a first velocity. If the portion of the battery electrode that is currently cut is the gap portion, the velocity at which the battery electrode moves relative to the laser generator in the lengthwise direction of the battery electrode is adjusted to be a second velocity. The first velocity is smaller than the second velocity.

A difference between the length of the electrode tab contour that the laser generator cuts in a preset time and the length of the gap portion that the laser generator cuts in the preset time is within a preset length range.

As shown in FIG. 5, it is assumed that when the laser generator cuts the gap portion, the movable member carrying the battery electrode moves at the velocity V1. When the laser generator cuts the electrode tab, the controller reduces the velocity (i.e., V1) at which the movable member carrying the battery electrode moves. Correspondingly, the velocity (i.e., the combined velocity V) at which the battery electrode moves relative to the laser generator is reduced. The length (i.e., V*t) of the electrode tab contour that the laser generator cuts in the unit time t is reduced. As such, the length of the electrode tab contour that the laser light cuts in the unit time t is approximately equal to the length of the gap portion that the laser light cuts in the unit time t. For example, the difference between the length of the electrode tab contour that the laser light cuts in the unit time t and the length of the gap portion that the laser light cuts in the unit time t is within the preset length range. In some embodiments, the length of the electrode tab contour that the laser light cuts in the unit time t is equal to the length of the gap portion that the laser light cuts in the unit time t.

If the laser generator emits the laser light at the constant power when the laser generator cuts the electrode tab and the gap portion, the difference between the length of the electrode tab contour that the laser light cuts in the unit time t and the length of the gap portion that the laser light cuts in the unit time t is within the preset length range, and the difference between the laser energy that the unit length of the electrode tab contour receives and the laser energy that the unit length of the gap portion receives is within the preset energy range. In some embodiments, the laser energy that the unit length of the electrode tab contour receives is equal to the laser energy that the unit length of the gap portion receives.

The laser generator may emit the laser light at different powers when the laser generator cuts the electrode tab and the gap portion. In some embodiments, the power of the laser light emitted from the laser generator may be adjusted to the first power when the laser generator cuts the electrode tab, and the power of the laser light emitted from the laser generator may be adjusted to the second power when the laser generator cuts the gap portion. The first power is greater than the second power. As such, the laser energy emitted from the laser generator cutting the electrode tab is greater than the laser energy emitted from the laser generator cutting the gap portion. Further, when the laser generator cuts the electrode tab, the controller reduces the velocity at which the movable member carrying the battery electrode moves, such that the length V*t of the electrode tab contour that the laser generator cuts in the unit time t is reduced. Thus, the laser energy received by the unit length of the electrode tab contour in the unit time t increases to approach the laser energy received by the unit length of the gap portion in the unit time t.

In addition, when the laser generator cuts the electrode tab, a ratio of a magnitude of the velocity at which the battery electrode moves relative to the laser generator in the widthwise direction of the battery electrode over a magnitude of the velocity at which the battery electrode move relative to the laser generator in the lengthwise direction of the battery electrode is approximately equal to a slope of the electrode tab contour.

As shown in FIG. 5, when the laser generator cuts the electrode tab, the battery electrode moves relative to the laser generator at the velocity V3 in the widthwise direction of the battery electrode and at the velocity V1 in the lengthwise direction of the battery electrode. The slope of the beveled edge 38 of the electrode tab, that is, the tangent of angle θ shown in FIG. 5, is a ratio of a height H of the electrode tab contour over a distance L that the battery electrode moves relative to the laser generator in the lengthwise direction of the battery electrode, that is a ratio of the magnitude of V3 over the magnitude of V1.

In some embodiments, the velocity at which the battery electrode moves relative to the laser generator in the widthwise direction of the battery electrode includes at least one of the velocity at which the laser light emitted from the laser generator moves in the widthwise direction of the battery electrode or the velocity at which the movable member carrying the battery electrode moves in the widthwise direction of the battery electrode.

In some embodiments, the velocity at which the battery electrode moves relative to the laser generator in the lengthwise direction of the battery electrode includes at least one of the velocity at which the movable member carrying the battery electrode moves in the lengthwise direction of the battery electrode or the velocity at which the laser light emitted from the laser generator moves in the lengthwise direction of the battery electrode.

In some embodiments, the velocity at which the battery electrode moves relative to the laser generator in the widthwise direction of the battery electrode is the velocity at which the laser light emitted from the laser generator moves in the widthwise direction of the battery electrode and the velocity at which the battery electrode moves relative to the laser generator in the lengthwise direction of the battery electrode is the velocity at which the movable member carrying the battery electrode moves in the lengthwise direction of the battery electrode. As such, when the laser generator cuts the electrode tab, the ratio of the magnitude of the velocity at which the laser light emitted from the laser generator moves in the widthwise direction of the battery electrode over the magnitude of the velocity at which the movable member carrying the battery electrode moves in the lengthwise direction of the battery electrode is equal to the slope of the electrode tab contour.

In the embodiments of the present disclosure, the controller adjusts the velocity at which the battery electrode moves relative to the laser generator in the lengthwise direction of the battery electrode, such that the velocity at which the movable member moves when the laser generator cuts the electrode tab is smaller than the velocity at which the movable member moves when the laser generator cuts the gap portion. Compared to the existing technology, when the laser generator cuts the electrode tab, the battery electrode spends more time under the laser generator to receive more laser energy. That is, the unit length of the electrode tab contour receives more laser energy. As such, the laser energy that the unit length of the electrode tab contour receives is approximately equal to the laser energy that the unit length of the gap portion receives. The problem that the laser energy is not enough for cutting the electrode tab completely apart from the remaining electrode and burrs are present because the unit length of the electrode tab contour receives less laser energy than the unit length of the gap portion may be avoided. At the same time, the problem that the laser energy is just enough for cutting the electrode tab but excessive for cutting the gap portion may be avoided.

The present disclosure provides a battery electrode cutting device. FIG. 6 is a schematic diagram of a battery electrode cutting device 60 according to another example embodiment. As shown in FIG. 6, the battery electrode cutting device 60 includes a controller 61 and a laser generator 62. The controller 61 is electrically connected to the laser generator 62. The controller 61 is configured to determine a portion of the battery electrode that is currently cut. The portions of the battery electrode includes a plurality of electrode tabs and gap portions each disposed between two adjacent electrode tabs. Based on the portion of the battery electrode, the controller 61 adjusts one or more cutting parameters of the laser generator 62, such that the one or more cutting parameters of the laser generator for cutting the electrode tab are different from the one or more cutting parameters of the laser generator for cutting the gap portion.

In some embodiments, the one or more cutting parameters include at least one of a power of laser light emitted from the laser generator 62 or a velocity at which the battery electrode moves relative to the laser generator 62.

In some embodiments, the velocity at which the battery electrode moves relative to the laser generator includes at least one of the velocity at which the battery electrode moves relative to the laser generator in the lengthwise direction of the battery electrode or the velocity at which the batter electrode moves relative to the laser generator in the widthwise direction of the battery electrode. The gap portions are arranged in the lengthwise direction of the battery electrode.

In addition, the battery electrode cutting device 60 further includes a movable member 63 carrying the battery electrode. The movable member 63 carrying the battery electrode is electrically connected to the controller 61. The velocity at which the battery electrode moves relative to the laser generator includes at least one of the velocity at which the movable member carrying the battery electrode moves or the velocity at which the laser light emitted from the laser generator moves.

The operation principle and the implementation method of the battery electrode cutting device provided by the embodiments of the disclosure are similar to that of the method for cutting the battery electrode as shown in FIG. 1. The differences will be described in detail and the similarities will not be repeated.

In the embodiments of the present disclosure, the battery electrode cutting device determines the portion of the battery electrode that is currently cut. Based on the portion of the battery electrode that is currently cut, the cutting parameters of the laser generator are adjusted such that the cutting parameters of the laser generator cutting the electrode tab are different from the cutting parameters of the laser generator cutting the gap portion. Compared to the existing technology that the cutting parameters of the laser generator cutting the electrode tab are the same as the cutting parameters of the laser generator cutting the gap portion, the embodiments of the present disclosure avoid the problem that the laser generator is unable to cut the electrode tab completely apart from the remaining electrode because a unit length of the electrode tab contour receives less laser energy than a same unit length of the gap portion. Thus, the burrs may be avoided, and the battery cell performance may be improved.

The present disclosure provides another battery electrode cutting device. Based on the technical solution illustrated in FIG. 6, when the controller 61 adjusts the cutting parameters of the laser generator based on the portion of the battery electrode that is currently cut, the controller 61 may perform the following process. If the portion of the battery electrode that is currently cut is the electrode tab, the power of the laser light emitted from the laser generator may be adjusted to be the first power. If the portion of the battery electrode that is currently cut is the gap portion, the power of the laser light emitted from the laser generator may be adjusted to be the second power. The first power is greater than the second power.

The difference between the laser energy emitted from the laser generator that cuts the preset length of the electrode tab contour and the laser energy emitted from the laser generator that cuts the preset length of the gap portion is within the preset length range.

In some embodiments, when the laser generator cuts the electrode tab and the gap portion, the battery electrode moves relative to the laser generator at the constant velocity in the lengthwise direction of the battery electrode.

The operation principle and the implementation method of the battery electrode cutting device provided by the embodiments of the disclosure are similar to that of the previously disclosed embodiments. The differences will be described in detail and the similarities will not be repeated.

In the embodiments of the present disclosure, the controller controls the laser generator to cut the electrode tab and the gap portion at different powers, such that the power of the laser generator cutting the electrode tab is greater than the power of the laser generator cutting the gap portion. Compared to the existing technology, the unit length of the electrode tab contour receives more laser energy. As such, the laser energy that the unit length of the electrode tab contour receives is approximately equal to the laser energy that the unit length of the gap portion receives. The problem that the laser energy is not enough for cutting the electrode tab completely apart from the remaining electrode and burrs are present because the unit length of the electrode tab contour receives less laser energy than the unit length of the gap portion may be avoided. At the same time, the problem that the laser energy is just enough for cutting the electrode tab but excessive for cutting the gap portion may be avoided.

The present disclosure provides another battery electrode cutting device. Based on the technical solution illustrated in FIG. 6, when the controller 61 adjusts the cutting parameters of the laser generator based on the portion of the battery electrode that is currently cut, the controller 61 may perform the following process. If the portion of the battery electrode that is currently cut is the electrode tab, the power of the laser light emitted from the laser generator may be adjusted to be the first power. If the portion of the battery electrode that is currently cut is the gap portion, the power of the laser light emitted from the laser generator may be adjusted to be the second power. The first power is greater than the second power.

The difference between the length of the electrode tab contour that the laser generator cuts in the preset time and the length of the gap portion that the laser generator cuts in the preset time is within the preset length range.

Further, when the laser generator cuts the electrode tab, the ratio of magnitude of the velocity at which the battery electrode moves relative to the laser generator in the widthwise direction of the battery electrode over magnitude of the velocity at which the battery electrode moves relative to the laser generator in the lengthwise direction of the battery electrode is the slope of the electrode tab contour.

In some embodiments, the velocity at which the battery electrode moves relative to the laser generator in the widthwise direction of the battery electrode includes at least one of the velocity at which the laser light emitted from the laser generator moves in the widthwise direction of the battery electrode or the velocity at which the movable member carrying the battery electrode moves in the widthwise direction of the battery electrode.

In some embodiments, the velocity at which the battery electrode moves relative to the laser generator in the lengthwise direction of the battery electrode includes at least one of the velocity at which the movable member carrying the battery electrode moves in the lengthwise direction of the battery electrode or the velocity at which the laser light emitted from the laser generator moves in the lengthwise direction of the battery electrode.

The operation principle and the implementation method of the battery electrode cutting device provided by the embodiments of the disclosure are similar to that of the previously disclosed embodiments. The differences will be described in detail and the similarities will not be repeated.

In the embodiments of the present disclosure, the controller adjusts the velocity at which the battery electrode moves relative to the laser generator in the lengthwise direction of the battery electrode, such that the velocity at which the movable member moves when the laser generator cuts the electrode tab is smaller than the velocity at which the movable member moves when the laser generator cuts the gap portion. Compared to the existing technology, when the laser generator cuts the electrode tab, the battery electrode spends more time under the laser generator to receive more laser energy. That is, the unit length of the electrode tab contour receives more laser energy. As such, the laser energy that the unit length of the electrode tab contour receives is approximately equal to the laser energy that the unit length of the gap portion receives. The problem that the laser energy is not enough for cutting the electrode tab completely apart from the remaining electrode and burrs are present because the unit length of the electrode tab contour receives less laser energy than the unit length of the gap portion may be avoided. At the same time, the problem that the laser energy is just enough for cutting the electrode tab but excessive for cutting the gap portion may be avoided.

In the embodiments of the present disclosure, the disclosed method and system may be implemented differently. For example, the embodiments describing the disclosed system may be for illustrative purposes. The division of units may only be a logic and function division. Actual implementation may include different divisions. For example, a plurality of units or assemblies may be combined or integrated into a different system. Certain features may be omitted or not executed. In addition, a mutual coupling, a direct coupling, or a communication connection as illustrated or discussed may be implemented through interfaces. The direct coupling or communication connection between devices or circuits may be electrical, mechanical, or in other forms.

Units described as separate components may or may not be physically separated. Components illustrated as circuits may or may not be physical circuits. That is, the components may be disposed in one location or may be distributed into a plurality of networked units. Based on the actual needs, some or all of the components may be selected to achieve the objectives of the embodiments of the present disclosure.

In addition, each functional unit in various embodiments may be integrated into one processing unit or may function as physically separated units. Two or more units may be integrated into one unit. The integrated unit may be implemented in hardware, software, or a combination of hardware and software.

The integrated units implemented in software may be stored in a computer-readable medium. The software function units may be stored in a storage medium, including a plurality of program instructions for a computer (e.g., a personal computer, a server, or a network device, etc.) or a processor to execute certain processes of the method embodiments. The storage medium may include a U-disk, a portable disk, a read-only memory (ROM), a random access memory (RAM), a magnetic disk, an optical disk, or other media that can store program instructions.

It should be understood by those skilled in the art that, for convenience and brevity of the description, a division of function modules/units is only intended to be illustrative. In practical applications, function assignments may be completed by different function modules/units as needed. That is, internal structures of a device may be divided into different function modules/units to perform some or all of the described functions. For specific operation process of the device, reference can be made to the corresponding process as illustrated in the embodiments of the present disclosure and will not be repeated herein.

The foregoing descriptions are merely some implementation manners of the present disclosure, but the scope of the present disclosure is not limited thereto. Any change or replacement that can be conceived by a person skilled in the art based on the technical scope disclosed by the present application should be covered by the scope of the present disclosure. A true scope and spirit of the invention is indicated by the following claims.

What is claimed is:

1. A method for cutting a battery electrode comprising:
determining whether a portion of the battery electrode that is currently being cut is one of a plurality of electrode tabs or one of gap portions each being between two adjacent ones of the plurality of electrode tabs; and
controlling one or more cutting parameters of a laser generator based on a determination result, the one or more cutting parameters of the laser generator being different for cutting the one of the electrode tabs from for cutting the one of the gap portions.

2. The method of claim 1, wherein the one or more cutting parameters include at least one of a power of laser light emitted from the laser generator or a relative velocity of a relative movement between the battery electrode and the laser generator.

3. The method of claim 2, wherein controlling the one or more cutting parameters includes:
in response to the portion of the battery electrode being the one of the electrode tabs, controlling the power of the laser light from the laser generator to be a first power;
in response to the portion of the battery electrode being the one of the gap portions, controlling the power of the laser light from the laser generator to be a second power; and
the first power is greater than the second power.

4. The method of claim 3, wherein a difference between a laser energy emitted from the laser generator for cutting a preset length of a contour of the one of the electrode tabs and a laser energy emitted from the laser generator for cutting the preset length of the one of the gap portions is within a preset energy range.

5. The method of claim 2, wherein the relative velocity includes at least one of a velocity at which a movable member carrying the battery electrode moves or a velocity at which the laser light emitted from the laser generator moves.

6. The method of claim 2, wherein:
the relative velocity includes at least one of a lengthwise relative velocity of a relative movement between the battery electrode and the laser generator in a lengthwise direction of the battery electrode or a widthwise relative velocity of a relative movement between the battery electrode and the laser generator in a widthwise direction of the battery electrode; and
the one of the gap portions is arranged in the lengthwise direction of the battery electrode.

7. The method of claim 6, wherein the lengthwise relative velocity is same when the laser generator cuts the one of the electrode tabs as when the laser generator cuts the one of the gap portions.

8. The method of claim 6, wherein controlling the one or more cutting parameters of the laser generator includes:
in response to the portion of the battery electrode being the one of the electrode tabs, controlling the lengthwise relative velocity to be a first velocity;
in response to the portion of the battery electrode being the one of the gap portions, controlling the lengthwise relative velocity to be a second velocity; and
a magnitude of the first velocity is smaller than a magnitude of the second velocity.

9. The method of claim 8, wherein a difference between a length of a contour of the one of the electrode tabs that the laser generator is configured to cut in a preset time period and a length of the one or more gap portions that the laser generator is configured to cut in the preset time period is within a preset length range.

10. The method of claim 6, wherein:
the portion of the battery electrode is determined to be the one of the electrode tabs; and
a ratio of a magnitude of the widthwise relative velocity to a magnitude of the lengthwise relative velocity equals a slope of a contour of the one of the electrode tabs.

11. The method of claim 6, wherein the widthwise relative velocity includes at least one of a velocity at which the laser light emitted from the laser generator moves in the widthwise direction of the battery electrode or a velocity at which a movable member carrying the battery electrode moves in the widthwise direction of the battery electrode.

12. The method of claim 6, wherein the lengthwise relative velocity includes at least one of a velocity at which a movable member carrying the battery electrode moves in the lengthwise direction of the battery electrode or a velocity at which the laser light emitted from the laser generator moves in the lengthwise direction of the battery electrode.

13. A battery electrode cutting device comprising:
a laser generator; and
a controller electrically connected to the laser generator and configured to:
determine whether a portion of the battery electrode that is currently being cut is one of a plurality of electrode tabs or one of gap portions each between two adjacent ones of the plurality of electrode tabs; and
control one or more cutting parameters of the laser generator based on a determination result, the one or more cutting parameters of the laser generator being different for cutting the one of the electrode tabs from for cutting the one of the gap portions.

14. The device of claim 13, wherein the one or more cutting parameters include at least one of a power of laser light emitted from the laser generator or a relative velocity of a relative movement between the battery electrode and the laser generator.

15. The device of claim 14, further comprising:
a movable member electrically connected to the controller and configured to carry the battery electrode;
wherein the relative velocity includes at least one of a velocity at which the movable member moves or a velocity at which the laser light emitted from the laser generator moves.

16. The device of claim 14, wherein:
the relative velocity includes at least one of a lengthwise relative velocity of a relative movement between the battery electrode and the laser generator in a lengthwise direction of the battery electrode or a widthwise relative velocity of a relative movement between the battery electrode and the laser generator in a widthwise direction of the battery electrode; and
the one of the gap portions is arranged in the lengthwise direction of the battery electrode.

17. The device of claim 16, wherein the widthwise relative velocity includes at least one of a velocity at which the laser light emitted from the laser generator moves in the widthwise direction of the battery electrode or a velocity at which a movable member carrying the battery electrode moves in the widthwise direction of the battery electrode.

18. The device of claim 16, wherein the lengthwise relative velocity includes at least one of a velocity at which a movable member carrying the battery electrode moves in the lengthwise direction of the battery electrode or a velocity at which the laser light emitted from the laser generator moves in the lengthwise direction of the battery electrode.
